(19) United States
(12) Patent Application Publication
(10) Pub. No.: US 2005/0065642 A1
(43) Pub. Date: Mar. 24, 2005

(54) Transport system, in particular an airport luggage transport system, and a controller for a transport system

(75) Inventors: Wolfgang Brixius, Neunkirchen A.Br. (DE); Bernhard Falkner, Nurnberg (DE); Andreas Gerle, Hilpoltstein (DE); Dominik Grafer, Dortmund-Wellinghofen (DE); Albrecht Hoene, Lappersdorf (DE); Gerhard Hoffmann, Nurnberg (DE); Rainer Junk, Grossenseebach (DE); Klaus-Peter Schwarzbach, Nurnberg (DE); Gojko Valencic, Coleyville, TX (US); Roland Ziegler, Furth (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 10/928,919

(22) Filed: Aug. 27, 2004

(30) Foreign Application Priority Data
Aug. 29, 2003 (DE) 103 39 951.8

(51) Int. Cl. G06F 7/00

(52) U.S. Cl. 700/230; 198/348

(57) ABSTRACT

A transport system, in particular an airport luggage transport system and a controller for the transport system are described. The transport system transports items to a predetermined destination on predefined transport routes via several branching locations. A master controller sets for each transported item a destination and a transport route, which are processed by one or more slave controllers. Each transported item is given an identification number that is identified by the slave controller. The master controller provides to the slave controller the destination associated with each identification number and associates with each destination at the branching locations a forwarding direction. Forwarding is processed by the slave controller without an interrogation of the master controller, based on the preset association at the branching locations.

### CROSS-REFERENCES TO RELATED APPLICATIONS

This application claims the priority of German Patent Application, Serial No. 103 39 951.8, filed Aug. 29, 2003, pursuant to 35 U.S.C. 119(a)-(d), the disclosure of which is incorporated herein by reference.

### BACKGROUND OF THE INVENTION

The invention relates to a transport system, in particular an airport luggage transport system, and a controller for a transport system of this type.

Airport luggage transport systems are special transport systems known in the art. The pieces of luggage are here transported to a predetermined destination along transport routes having a several branching locations. The transport is controlled by a master controller which ensures that the pieces of luggage reach the destination on the transport routes. The preset transport routes are processed by a slave controller which is not aware of either the destination or the predetermined route. When a piece of luggage reaches a branching location, the slave controller provides the master controller with the identification number of the piece of luggage and inquires in which direction in the piece of luggage is to be transported from here on. The slave controller then causes the piece of luggage to be transported in the proper direction defined by the master controller. The corresponding direction has to be interrogated at each branching location.

Slave controllers are typically only aware of the transport routes to the closest intermediate destinations. Accordingly, the master controller is always interrogated when an intermediate destination is reached. The routes necessary for travel from one intermediate destination to the next intermediate destination are therefore already stored in the slave controller; for example, the routes may have been transmitted by the master controller to the slave controller.

It is also known to associate with the branching locations switch tables that contain direction information for each piece of luggage.

DE 202 88 36 B discloses a pneumatic post system with a central multi-directional switch, wherein the containers are transported in by air pressure in tubes of a pneumatic tube system that includes branching locations. The transported containers have identification information which can be stored in central switching units in encoded form when the containers are sent. The identification information is read upon arrival by sensors associated with the central switching units; the central switching units interrogate a storage address that corresponds to the identification information to obtain the destination information. The switching units then control the switches at the branching locations based on the destination information associated with each identification information. The direction in which a transport container is routed is therefore determined by the master controller based on a transport route associated with the identification information.

A master controller hereby intervenes in the transport of the container, namely by determining the destination based on the identification information and, based on the determined destination, by setting the forwarding direction at the traversed branching location depending on the predetermined transport route.

Disadvantageously, this approach results in large data sets.

DE 411 62 83 A1 describes a transport system for transporting items over computed transport routes. The transported items are sewing material to be transported to a desired workstation (destination). The transported items are distributed by a plurality of distribution devices, which are connected with each other via transport rails. Each of the distribution devices is controlled by an electronic control circuit that is connected with a master computer that completely controls the transport system. The master computer generates the destination signals for each of the transported items, which are then transported onwards. The control circuits store the destination commands transmitted by the master computer in a destination-command-table. For proper association, the transported items are provided with identification numbers that can be read by numerical reading devices. The transport system consists of several transport lines which are connected with each other by bridge rails. In the event of a malfunction, for example in the event of a backup, the master computer routes the items around the backup over a different transport route. The control mode of the distribution devices allows the transported item to reach their destination even if a transport path malfunctions.

The master computer herein also executes the control functions directly in the form of destination definitions, which can disadvantageously also requires transmission of large data sets.

It would therefore be desirable and advantageous to improve a transport system with a large number of branching locations and to provide a corresponding controller, which obviates prior art shortcomings and requires only a small data volume to be handled by the controller.

### SUMMARY OF THE INVENTION

According to one aspect of the invention, a transport system, in particular an airport luggage transport system, for transporting items to a predetermined destination on predefined transport routes having a plurality of branching locations is disclosed. The transport system includes a master controller capable of setting for each transported item a destination and a transport route, which are processed by a slave controller. An identification number is associated with each transported item and recognized by the slave controller. The master controller provides to the slave controller the destination associated with each identification number, and associates with each destination at the branching locations a forwarding direction. The forwarding operation is executed by the slave controller without interrogating the master controller, based on the preset association at the branching locations.

According to another aspect of the invention, a controller for a transport system of the aforedescribed type is disclosed.

Destination and transport routing information are hence separated from each other, which significantly reduces the data volume. There is a clear division between the tasks assigned to the master controller and the slave controller. Accordingly, the basic idea of the solution is the separation of destination information and routing information. Typically, destinations change more frequently than the routes to those destinations, so that routing information remains essentially unchanged when routing and destination information are separated. This significantly reduces the data traffic. The separation of routing and destination information is reflected in a separation between master controller and slave controller. The master controller presets the routing and the destinations for the slave controller, whereas the slave controller only executes the preset commands. The destination information does not include information about the route by which the transported items will arrive at the destination. The routing information for each branching location is preferably stored in a switch table, wherein the switch tables define the various transport routes independent of the point of origin (if several points of origin exist) and of the destination. Not every transported item can be transported over every possible transport route based on this association. Once the slave controller receives this information, it can execute the transport commands independently, without having to interrogate the master controller.

The performance of the transport system can be improved by associating a destination with an intermediate destination or with a final destination.

An identification number can be associated with each transported item, whereby transported items with the same identification number are routed to the destination via the same transport routes.

The identification number can be readable by a sensor or tracked by the master controller in accordance with a data tracking process.

The communication between the master controller and the slave controller can be simplified by having the master controller store the destinations of the transported items in a destination table which can be accessed by the slave controller.

Moreover, the communication can be simplified by having the master controller store the directions of the transported items at a branching location in form of a switch table, which can be accessed by the slave controller.

The performance of the transport system can be improved by making it possible to change each switch table during operation.

Advantageously, the switch tables can be changed in the event of a backup of the transported items so as to enable the transported items to go around the backup.

The performance of a system with several directly adjacent control regions can be improved by having the slave controller transmit at least the identification number and the destination of the transported item when a transported item is transferred from one region to another region.

Advantageously, in the event of a conflict, the slave controller interrogates the master controller about the destination and the direction of the transported item.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic diagram of a transport system according to the invention; and

FIG. 2 shows controllers for the transport system of FIG. 1.

### DETAILED DESCRIPTION OF PREFERRED EMBODIMENTS

These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

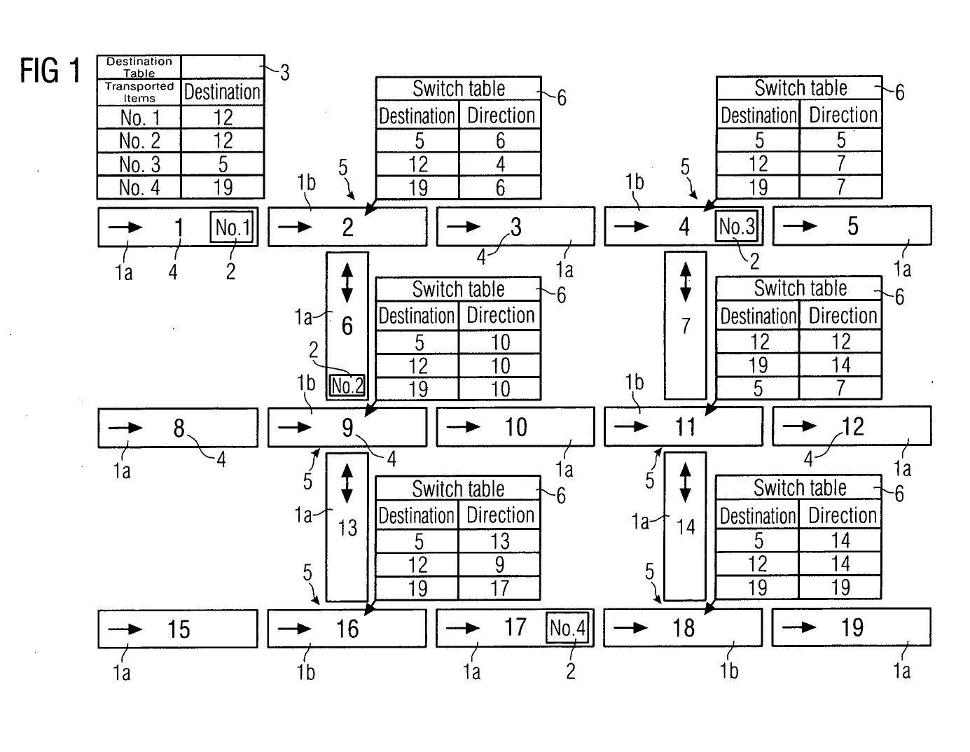

Turning now to FIG. 1, there is shown a schematic diagram of a transport system with several consecutive transport units 1a, 1b capable of transporting items 2 to predetermined destinations. An identification number No. 1, No. 2, No. 3, No. 4 is associated with each transported item 2. The destination for each transported item is stored in a destination table 3.

All transport units 1a, 1b are indicated in FIG. 1 with the reference numeral 4. The arrows in the boxes for the transport units indicate the transport direction of the corresponding transport units 1a, 1b.

For example, the destinations entered in the destination table 3 refer to the transport units 1b (reference numerals 12, 5, 19 shown in the boxes of the transport units) which can represent an intermediate destination or a final destination.

As indicated in FIG. 1, the transport units 1b represents switching locations 5, from where the transported items 2 are routed onward in one of two different directions. The switching locations 5 can represent switches, corner transfer stations, lifting tables, rotary tables, rotating lifting tables, pushers, pullers, sorters and the like. The transport units 1b (reference numerals 6, 7, 13, 14) can be operated in two opposite transport directions. With each switching locations 5 there is associated a switch table 6, where a direction is defined depending on the destinations (transport units 1a with the reference numerals 5, 12, 19). The directions in the switch tables 6 are entered according to the values for the two immediately adjacent transport units 1a.

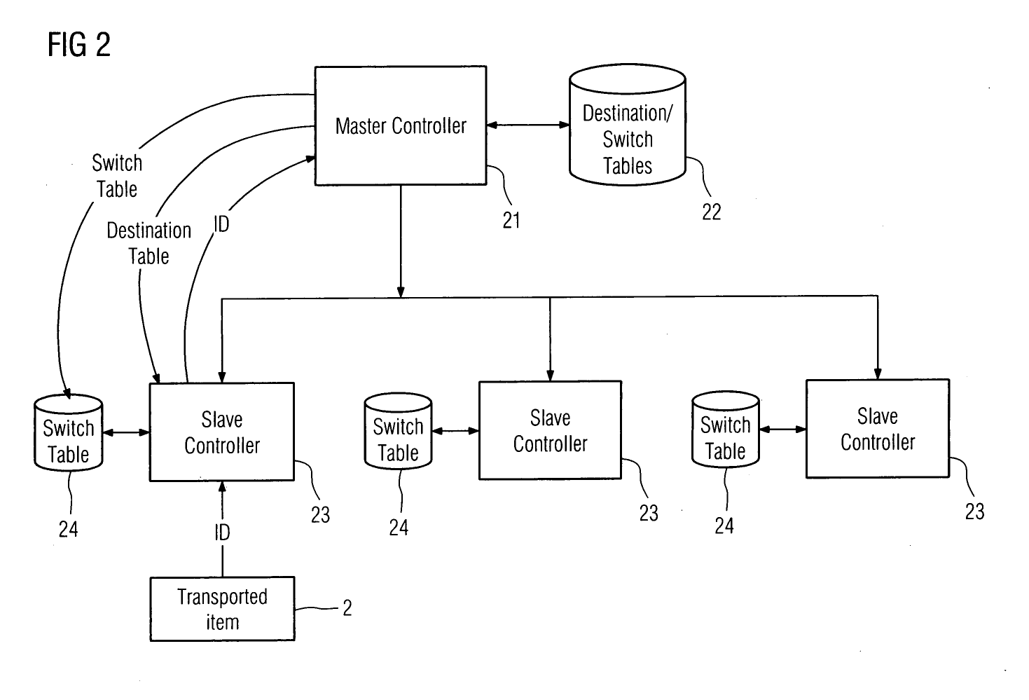

Referring now also to FIG. 2, the transport of the items is controlled by a master controller 21 and one or more slave controllers 23, whereby the master controller 21 defines the destination of each transported item in the form of a destination table 3 that can be stored in database 22, and transmits this table to the slave controller(s) 23. Alternatively, the slave controller(s) 22 can download the actual destination table 3 through suitable software. The slave controller(s) 22 cause(s) the corresponding transported item 2 to be transported on the predefined transport route (sequence of the transport units 1a, 1b in FIG. 1) to the destination stored in the destination table 3. The transport routes for the various transported items 2 are specified in detail in the switch tables 6 that can also be stored in database 24 associated with the slave controller(s) 23. In this way, one of two possible directions is uniquely set in the slave controller 23 for each transported item 2 at each switching locations 5 depending on the destination of the transported item 2 (destination table 3), and the transported item 2 is routed onward in this direction. The switch tables 6 can be changed at any time during the operation by the master controller 21. This applies also to the destination table 3. More particularly, the switch tables 6 can be changed in the event that the transported items 2 back up, so as to get around the backup.

Sensors (not shown) can be provided in the various transport units 1b to read the identification numbers No. 1, No. 2, No. 3, No. 4 and thereby also the actual transported item 2. Alternatively, the transported items 2 can also be tracked by the slave controller(s) 23 by using a data tracking process.

With the transport system depicted in FIG. 1, transported items 2 with the same identification number No. 1, No. 2, No. 3, No. 4 reach the destination via the same transport routes.

Returning now to FIG. 1, an exemplary transported item 2 with the identification number No. 2 is located at a switching locations 5, namely the transport unit 1b with the reference numeral 9. From the destination table 3, the slave controller obtains for this transported item 2 as destination the transport unit 1a with the reference numeral 12. For this particular destination, the associated switching table 6 includes the direction of the transport unit 1a with the reference numeral 10. Accordingly, the transported item 2 with the identification number No. 2 is routed to the transport unit 1a with the reference numeral 10.

The transported items 2 are routed onward at the other switching locations 5 in a similar manner.

If the transport system is organized as a network of slave controllers 23, as depicted in FIG. 2, then the master controller 21 need not be interrogated when a transported item 2 is transferred from one control region (a slave controller 23) to another immediately adjacent control region (an immediately adjacent slave controller 23), because the transferring control region transfers to the receiving control region at least the identification number No. 1, No. 2, No. 3, No. 4 and the destination of the transported item 2.

In the event of conflicts, however, the slave controller(s) 23 can interrogate the master controller 21 about the destination and direction of the transported item 2.

With this type of controller, a control network of arbitrary size for a transport system can be implemented.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A transport system, in particular an airport luggage transport system, for transporting items to a destination on predefined transport routes having a plurality of branching locations, comprising:
a master controller setting for each transported item the destination and a transport route associated with the destination; and
a slave controller receiving from the master controller for each destination a forwarding direction at the branching locations,
wherein the slave controller identifies an identification number associated with each transported item and transmits the identification number to the master controller, which provides to the slave controller the destination associated with the identification number, and
wherein the slave controller forwards the item without an interrogation of the master controller, based on the forwarding directions stored at the slave controller.

2. The transport system of claim 1, wherein the destination is an intermediate destination or a final destination.

3. The transport system of claim 1, wherein transported items having the same identification number are routed to the destination via the same transport routes.

4. The transport system of claim 3, wherein the identification number is read by a sensor or tracked by the master controller in accordance with a data tracking process.

5. The transport system of claim 1, wherein the destination of a transported items is stored by the master controller in a destination table accessible by the slave controller.

6. The transport system of claim 1, wherein the directions of the transported items at a branching location are stored by the master controller in form of a switch table accessible by the slave controller.

7. The transport system of claim 6, wherein a switch table can be changed during operation.

8. The transport system of claim 6, wherein a switch table is changed in the event of a backup of the transported items so as to go around the backup.

9. The transport system of claim 1, wherein several immediately adjacent control regions having separate slave controllers are provided, and wherein when a transported item is transferred from one control region to another control region, at least the identification number and the destination of the transported item is transmitted by the slave controller of one control region to the slave controller of the other control region.

10. The transport system of claim 1, wherein in the event of a conflict, the slave controller interrogates the master controller about the destination and the direction of the transported item.

11. The transport system of claim 1, wherein the switch table is transmitted by the master controller to the slave controller and stored at the slave controller.

12. A controller for a transport system, in particular an airport luggage transport system, for transporting items to a destination on predefined transport routes having a plurality of branching location, comprising:
a master controller setting for each transported item the destination and a transport route associated with the destination; and
a slave controller receiving from the master controller for each destination a forwarding direction at the branching locations,
wherein the slave controller identifies an identification number associated with each transported item and transmits the identification number to the master controller, which provides to the slave controller the destination associated with the identification number, and
wherein the slave controller forwards the item without an interrogation of the master controller, based on the forwarding directions stored at the slave controller.

13. A method for transporting items to a destination on predefined transport routes having a plurality of branching location, comprising the steps of:
in a master controller, setting for each transported item the destination and a transport route associated with the destination;
the master controller transmitting for each destination a forwarding direction at the branching locations to a slave controller; and
the slave controller identifying an identification number associated with each transported item;
the slave controller transmitting the identification number to the master controller, which provides to the slave controller the destination associated with the identification number; and
the slave controller forwarding the item without an interrogation of the master controller, based on the forwarding directions stored at the slave controller.
